(19) United States
(12) Patent Application Publication
(10) Pub. No.: US 2016/0253863 A1
(43) Pub. Date: Sep. 1, 2016

(54) METHOD OF PLAYING A SPORTING EVENT INTERACTIVE BOARD GAME

(71) Applicants: William Anthony Cox, Scottsville, NY (US); Charles Richard Robinson, Caledonia, NY (US)

(72) Inventors: William Anthony Cox, Scottsville, NY (US); Charles Richard Robinson, Caledonia, NY (US)

(21) Appl. No.: 14/886,460

(22) Filed: Oct. 19, 2015

Related U.S. Application Data
(60) Provisional application No. 62/121,458, filed on Feb. 26, 2015.

(51) Int. Cl. G07F 17/32

(52) U.S. Cl. CPC G07F 17/3216; G07F 17/3286; G07F 17/3288; G07F 17/3276; G07F 17/3241; G07F 17/3248

(57) ABSTRACT

A method of playing a sporting event interactive board game is provided. A sporting event is displayed on at least one of a television, a computer monitor or other electronic device. The present invention includes a game board. The game board includes a playing surface having a plurality of betting spaces forming a path. Each player may purchase at least one of the betting spaces to play the game. The present invention further includes a chip. A position of the chip is determined randomly and placed on one of the betting spaces. The chip is then moved along the path of the betting spaces based on certain plays performed during the sporting event. When a score or an end of a period occurs during the sporting event, the player who purchased the betting space in which the chip is currently resting is paid.

### CROSS-REFERENCE TO RELATED APPLICATION

This application claims the benefit of priority of U.S. provisional application No. 62/121,458, filed Feb. 26, 2015, the contents of which are herein incorporated by reference.

### BACKGROUND OF THE INVENTION

The present invention relates to a board game and, more particularly, to an interactive sports and board game.

There presently are no board games that use a sporting event to determine how and when to make moves on a board game.

As can be seen, there is a need for a game that is interactive with a sporting event.

### SUMMARY OF THE INVENTION

In one aspect of the present invention, a method of playing a sporting event interactive board game comprising: displaying a sporting event on at least one of a television, a computer monitor or other electronic device; providing a game board comprising a playing surface having a plurality of betting spaces forming a path around a perimeter of the game board, wherein each of a plurality of players purchases at least one of the plurality of betting spaces; providing a chip; determining a position of the chip, wherein the position comprises a random selection of one plurality of betting spaces; moving a chip along the path of the plurality of betting spaces based on a plurality of plays performed during the sporting event; and paying a player a monetary value when a score occurs during the sporting event and the chip is positioned on the betting space purchased by the player.

These and other features, aspects and advantages of the present invention will become better understood with reference to the following drawings, description and claims.

### BRIEF DESCRIPTION OF THE DRAWINGS

FIG. 1 is a schematic view of the present invention illustrating the game being played as a table board game;

FIG. 2 is a flow chart of an embodiment of how to play the board game version of the present invention;

FIG. 3 is a schematic view of the present invention illustrating the table board game;

FIG. 4 is a flow chart of a game being played in a group setting with an electronic version of the board game on a monitor;

FIG. 5 is a schematic view illustrating the game being played on an electronic monitor;

FIG. 6 is a flow chart of the present invention being played on an electronic device; and

FIG. 7 is a schematic view illustrating the game being played on an electronic device.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes an interactive television sports board game involving watching a sports game on television and playing the board game at the same time. The game of the present invention establishes a set of rules relating to events that happen in a sports game on television and provides a game board and pieces to make moves to determine a winner. The present invention may also include a digital or automated game board that may be played on a computer, such as a smart device.

To play the game, a football game or other sporting event is watched on a television, a computer monitor or other electronic device, and the board game is set up with all the players buying at least one square on the board. By following the game rules and events of the sporting event, moves are made on the board game until a winner is determined when there is a scoring play or an end of a period. An automated or digital version can be developed so participants do not need to be present to play. The present invention may be utilized with football, baseball, basketball, hockey, tennis, golf, and the like.

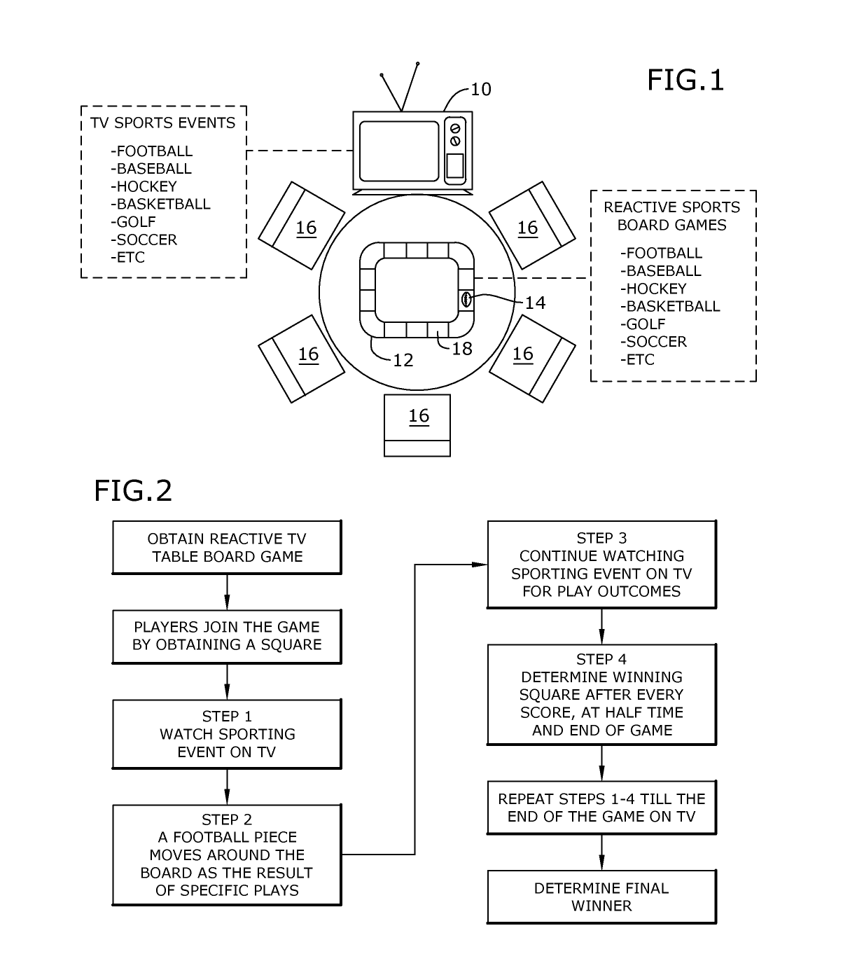

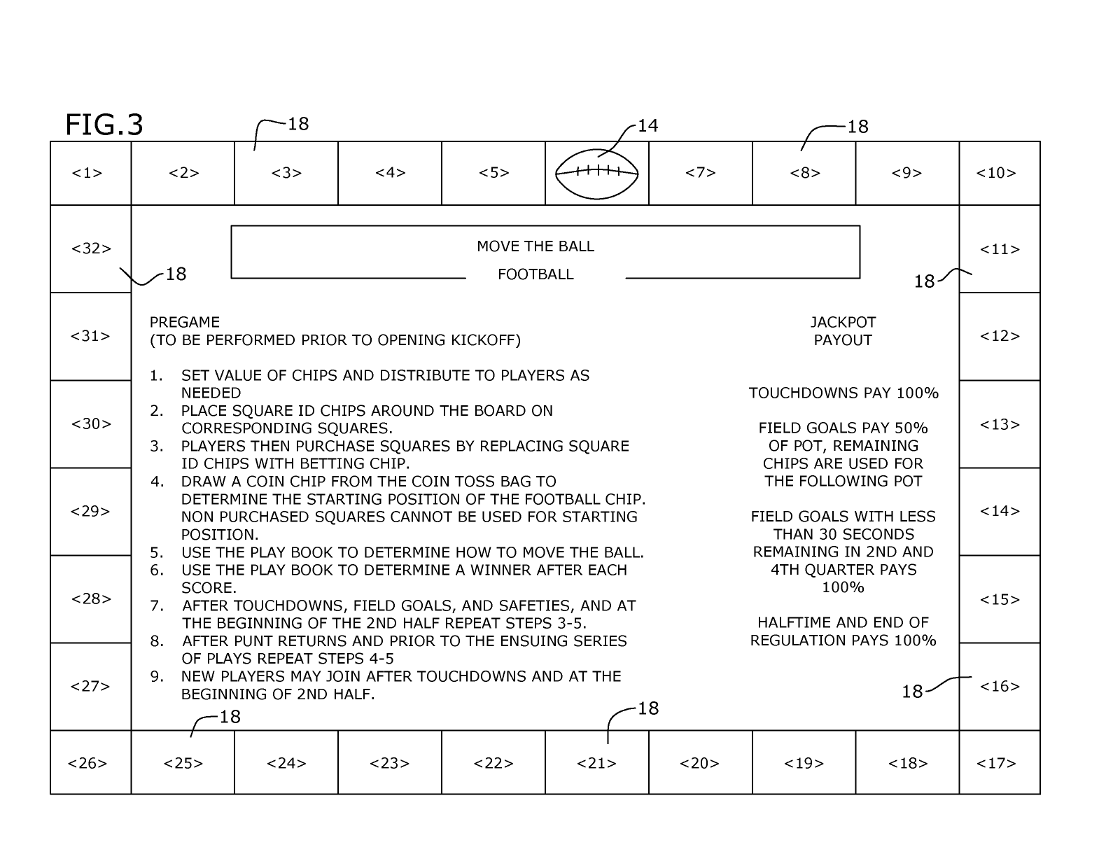

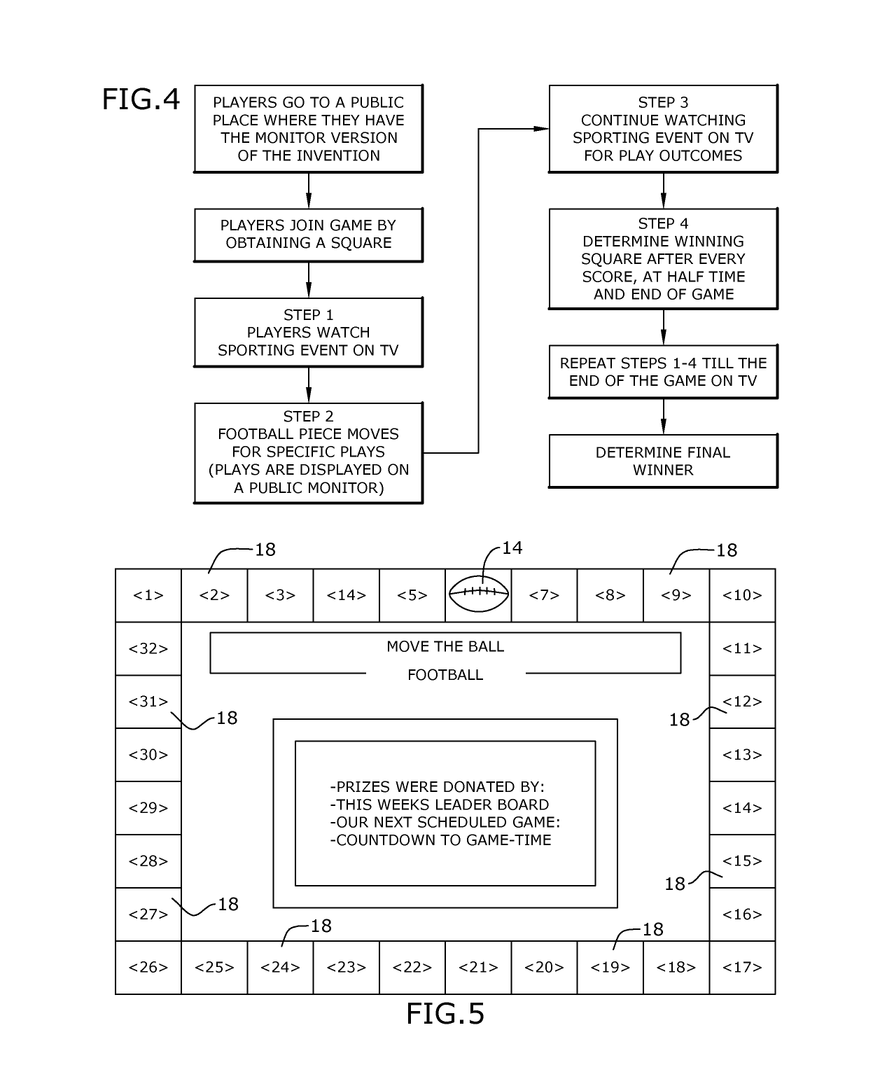

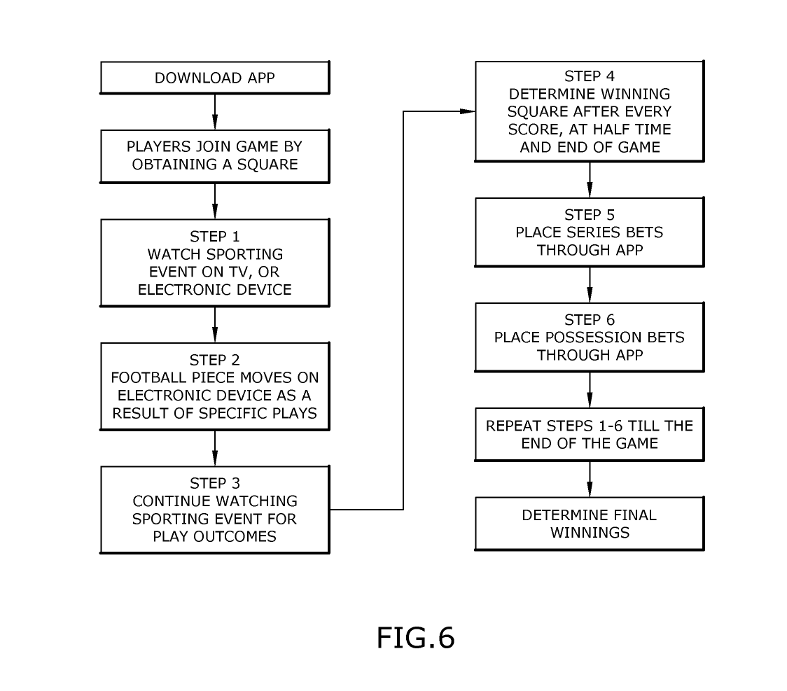

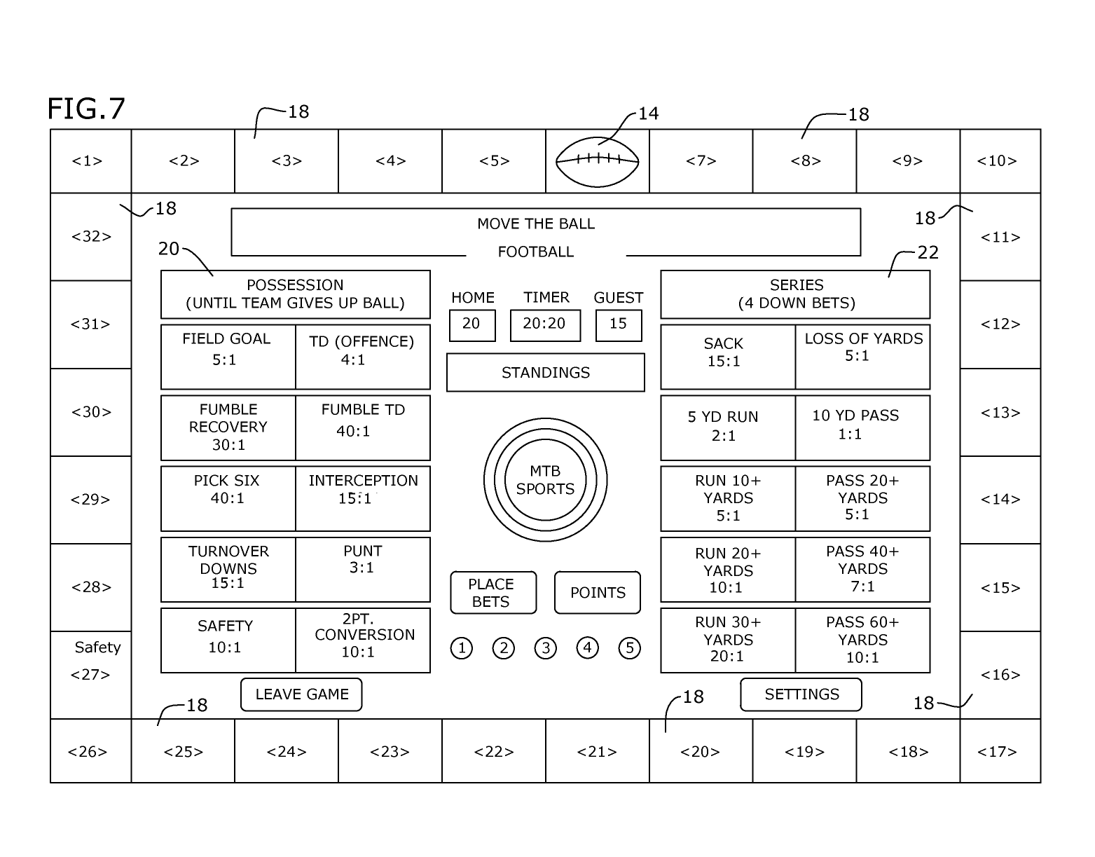

Referring to FIGS. 1 through 7, the present invention includes a method of playing a sporting event interactive board game. A sporting event is displayed on at least one of a television 10, a computer monitor or other electronic device. The present invention includes a game board 12. The game board 12 includes a playing surface having a plurality of betting spaces 18 forming a path. Each player 16 may purchase at least one of the betting spaces 18 to play the game. The present invention further includes a chip 14. A position of the chip 14 is determined randomly and placed on one of the betting spaces 18. The chip is then moved along the path of the betting spaces 18 based on certain plays performed during the sporting event. When a score or an end of a period occurs during the sporting event, the player 16 who purchased the betting space 18 in which the chip 14 is currently resting is paid.

To determine the initial spot of the chip 14, the plurality of betting spaces 18 may be sequentially numbered. One of the players 16 may randomly draw a number. The chip 14 is then placed on the betting space 18 with the corresponding number. The chip 14 may then either move clockwise or counter clockwise along the path. Once a score or a period ends in the sporting event and a player 16 is paid out, a random selection occurs again to determine the position of the chip 14. In certain embodiments, a play in the sporting event determines whether the chip 14 is moving clockwise or counter clockwise. For example, the chip 14 may start off moving counter clockwise. If there is a turnover during the sporting event, the chip 14 may then start moving clockwise.

In certain embodiments, the present invention may include a plurality of identification chips and a plurality of betting chips. Each of the plurality of identification chips covers one of the betting spaces 18. When the player 16 purchases a betting space 18, the identification chips are then replaced with a betting chip to identify which betting spaces 18 have been purchased by whom. Each of the betting chips may cost a predetermined amount of money. The money is pooled and then distributed once a score or an end of a period occurs. In certain embodiments, no more than one player 16 can purchase each of the plurality of betting spaces 18.

The present invention may include additional betting opportunities. For example, a plurality of possession bets 20 and a plurality of series bets 22 may be disposed on the playing surface in between the path. The possession bets 20 allows the players 16 to place bets while a certain team has possession of the ball. Series bets 22 are bets made within a series, which in football would include within a set of downs. The possession bets 20 and the series bets 22 allows the players 16 to win and lose bets in between the main betting occurring during the game, which includes the purchased betting spaces 18.

As mentioned above, the present invention may be played on a physical game board or on an electronic game board. The electronic game board may be played in a central location, such as a sports bar or restaurant. The players may enter the game and purchase betting spaces 18 using an electronic device. An electronically displayed chip may automatically move about the path when a play has been made in the live sporting event. In alternate embodiments, the present invention may be played remotely via a software application on a smart device, such as a computer, laptop, tablet, phone, and the like.

Each game may include a “playbook” to describe the rules. Different sports would include different playbooks. Below is an example of a playbook for an American football sporting event interactive game.

### The Playbook

Table of Contents

The Game . . . Section 1

Game Pieces . . . Section 2

Glossary . . . Section 3

The Rules . . . Section 4

Kickoff . . . Section 4.1

Offensive Play . . . Section 4.2

Punts . . . Section 5

Field Goal Attempts . . . Section 6

Jackpots . . . Section 7

Overtime Rules . . . Section 8

Section 1: THE GAME

Move The Ball Football is a interactive sports television game. It is designed to be played while watching a live broadcast of a football game, so you're going to want the TV to be visible to everyone. It's important the “score banner” (the small, on screen graphic showing the score, clock, and down/distance) be visible as well, as this will show the “down and distance” of an ensuing play. Before the game begins use the “Pre Game” section on the board to get started. Once you're set up and ready to go refer to the PLAY BOOK to determine how and when to move the FOOTBALL CHIP. Use the COIN TOSS CHIPS to determine the random starting locations of the FOOTBALL CHIP. It is important to know what kind of play is taking place. There are only 4 different “formations” or types of plays: Kickoff, Offensive, Punt, and Field Goal. Use these formations to determine which set of rules you should be using on a particular play. During Offensive plays use the down and yardage displayed on the TV score banner to determine if the previous play resulted in a positive gain, or a loss of yardage. For example, a play begins on 1^{st} down and 10 yards to go. Before the following play the TV banner displays 2^{nd} down and 8 yards to go. This means that on 1^{st} down there was a gain of 2 yards. Positive gains by the offense result in a move 1 square forward as you will see in the “Offensive Plays” section. Penalties do not count in the game. The ball cannot be moved by a penalty. Most penalties negate the result of a play however if a penalty is declined then the play counts. If a penalty results in the addition of yardage on the end of a play then use that result as a positive gain. If a penalty negates the play and it must be repeated do not move the FOOTBALL CHIP. Holding for example will negate a positive gain for the offense, and that down must be repeated. Incomplete passes and plays that gain 0 yards are considered “NO MOVE PLAYS”. Other “NO MOVE PLAYS” include QB spikes, touchbacks, fair catches, and downed punts. ALL TURNOVERS RESULT IN A MOVE ONE SPACE BACKWARDS AND THIS DIRECTION IS MAINTAINED UNTIL THE NEXT TURNOVER, PUNT, OR KICKOFF. While you may be confused at this point don't be, simply determine the type of play and refer to that section of “The PLAY BOOK to see all the possible outcomes of a play, and the corresponding move. Remember that safeties and field goals increase the size of the ensuing jackpot, as described under “Jackpots” in the PLAY BOOK and you MUST REPURCHASE YOUR SQUARE before the ensuing kickoff.

Section 2: Game Pieces

Item #1—“The Game Board”

Used to determine each players position in the game and the movement of THE FOOTBALL CHIP.

Used to determine a winner of the “Jack Pot”

Has the basic rules on it

Item #2—“Coin Toss Bag” (or) Computer Generated Random Draw

Used to hold the COIN TOSS CHIPS so a blind draw can take place to determine the starting position of THE FOOTBALL CHIP

Item #3—“Coin Toss Chips numbered 1 thru 32” (or) random Draw—32 coin chips are placed in the COIN TOSS BAG or a computer generated random draw

Before kickoffs and after punts coin toss determines starting position of the FOOTBALL CHIP on the board

If the COIN TOSS CHIP drawn does not match a square that was purchased by a player draw another chip from the coin toss bag

Item #4—“The Football Chip” (or) Piece

Moves around the board clockwise to start the game.

The direction the ball moves is reversed by a turnover

After scores and punts the direction always resets to clockwise

Item #5—“Square ID Chips” (or) Player Profile

When a player purchases a square they replace the SQUARE ID CHIP on the board with a BETTING CHIP

After a score the SQUARE ID CHIP must be returned to the board, or repurchased using a BETTING CHIP

New Players can only enter the game at halftime or after a TD

Item #6—“Game Case” (or) Smart Phone/Electronic Device

Used to hold all of the components of the MOVE THE BALL FOOTBALL.

Item #7—“Betting Chips”

used to purchase squares and re-ante after a TD or Field Goal

after a score BETTING CHIPS are distributed to winner as described in the “Jackpot” section

Item #8—“The Playbook ” (or) Settings/Rules

contains all the rules and explains how to move the ball during kickoffs, offensive snaps, punts and field goal attempts.

Section 3: Glossary:

Ball Carrier—The player who owns the square the football is on is known as the “ball carrier”

Defense—The player who owns a square directly behind ball carrier is the “defense”

Ante—The cost of one square on the board.

Jackpot—The Betting Chips in the center of the Board during play.

Coin Toss—The process of drawing a Coin Toss Chip out of the Coin Toss Bag to determine the starting position of the Football Chip

Reset the Game—When players Re-Ante to purchase their square and a Coin Toss Chip is drawn.

Turnover—is when the offense gives up the ball without punting the ball. It results in moving the football one space backwards and this direction is continued until the next turnover or “Coin Toss”.

Section 4: The Rules

Moving the ball—After any “Coin Toss” The FOOTBALL CHIP is placed on that square and begins moving clockwise. After a turnover the FOOTBALL CHIP is moved 1 square backwards (opposite direction) and continues to move in that direction until another turnover or “Coin Toss”.

Section 4.1: KICKOFF

Any return attempt: MOVE ONE SPACE FORWARD

Touchbacks and kicks out of bounds: NO MOVE

Successful onside kick: TURNOVER

Lost fumble during return: TURNOVER

Return for touchdown: JACKPOT to BALL CARRIER

Kicking team recovers in end zone: JACKPOT to DEFENSE

Section 4.2: OFFENSIVE SNAPS

Any play resulting in a 1-19 yard positive gain: MOVE 1 SPACE FORWARD

Any play resulting in a 20-29 yard positive gain: MOVE 2 SPACES FORWARD

Any play resulting in a 30-39 yard positive gain: MOVE 3 SPACES FORWARD

Any play resulting in a 40-49 yard positive gain: MOVE 4 SPACES FORWARD

Any play resulting in a 50-59 yard positive gain: MOVE 5 SPACES FORWARD

Any play resulting in a 60-69 yard positive gain: MOVE 6 SPACES FORWARD

Any play resulting in a 70-79 yard positive gain: MOVE 7 SPACES FORWARD

Any play resulting in a 80-89 yard positive gain: MOVE 8 SPACES FORWARD

Any play resulting in a 90-99 yard positive gain: MOVE 9 SPACEs FORWARD

Any play resulting in a loss of yardage: MOVE 1 SPACE BACKWARD

Any play resulting in a gain of 0 yards: NO MOVE

Fumble/Interception/Unsuccessful 4^{th} down: TURNOVER

Pass/Run for Touchdown: JACKPOT to BALL CARRIER

Fumble/Interception returned for touchdown: JACKPOT to DEFENSE

Any play beginning at the 20 yard line or closer is considered a RED ZONE

PLAY. ALL RED ZONE PLAYS RESULT IN A MOVE 1 SPACE FORWARD except for “Turnovers”

Section 5: PUNTS

returns for touchdowns (blocked punts included): JACKPOT to BALL CARRIER

Returns, touchbacks, fair catches, downed punts: COIN TOSS

Lost fumbles on punts are treated as offensive first downs: MOVE ONE SPACE FORWARD

Fake punts/fumbled snaps are treated as offensive snaps; depending on result of play refer to OFFENSIVE PLAYS for move.

Section 6: FIELD GOAL ATTEMPTS

Fake FGs, Blocked FGs and fumbled snaps are treated as offensive plays

Missed field goals are treated as turnovers.

Completed field goals: ½ JACKPOT TO BALL CARRIER

Section 7: JACKPOTS

Offensive Touchdown: Pay the ball carrier, reset game.

Defensive Touchdown: Pay the defense, reset game

Kickoff and punt returns for touchdowns pay the ball carrier, reset game

Successful Field goals pay the ball carrier ½ of the pot, reset game. If there is less than 30 seconds left at the Half or the end of the game, do not re-ante and leave half of the pot there for the kick off.

Safety. Reset game (Pot increases 1 Betting Chip per player) the following free kick treated as KICKOFF.

Section 8: Overtime Rules

Overtime begins the same way the regular game begins however the scores and jackpots are treated differently.

On first touchdown JACKPOT TO BALL CARRIER

If first team scores a field goal PAY THE BALL CARRIER HALF THE POT no ante

If there is a field goal on the next possession PAY THE BALL CARRIER HALF THE POT AND REANTE. Continue with the game and on the next score PAY THE BALL CARRIER FULL POT.

If on the second possession there is no tying field goal, pay the defense after the final play.

Penalties and conversion plays require no action.

It should be understood, of course, that the foregoing relates to exemplary embodiments of the invention and that modifications may be made without departing from the spirit and scope of the invention as set forth in the following claims.

What is claimed is:

1. A method of playing a sporting event interactive board game comprising:
displaying a sporting event on at least one of a television or a computer monitor;
providing a game board comprising a playing surface having a plurality of betting spaces forming a path, wherein each of a plurality of players purchases at least one of the plurality of betting spaces;
providing a chip;
placing the chip at a position on the game board, wherein the position comprises a random selection of one of the plurality of betting spaces;
moving a chip along the path of the plurality of betting spaces based on a plurality of plays performed during the sporting event; and
paying a player a monetary value when a score or an end of a period occurs during the sporting event, wherein the chip is positioned on the betting space purchased by the player.

2. The method of claim 1, wherein no more than one player purchases each of the plurality of betting spaces.

3. The method of claim 1, further comprising a plurality of identification chips and a plurality of betting chips, wherein each of the plurality of identification chips cover one of the betting spaces and is replaced by one of the betting chips when a player purchases the betting space.

4. The method of claim 3, wherein each of the players purchases at least one of the plurality of betting chips for a specified price.

5. The method of claim 1, wherein the plurality of betting spaces are sequentially numbered.

6. The method of claim 5, wherein the random selection comprises the step of drawing a number and placing the chip on the betting space comprising a corresponding number.

7. The method of claim 1, wherein the chip moves clockwise or counter clockwise along the path.

8. The method of claim 7, wherein a play in the sporting event determines whether the chip is moving clockwise or counter clockwise.

9. The method of claim 1, further comprising the step of determining a position of the chip, wherein the position comprises a random selection of one plurality of betting spaces after each score that occurs during the sporting event.

10. The method of claim 1, wherein the playing surface further comprises a plurality of possession bets and a plurality of series bets disposed in between the path.
